(19) United States
(12) Patent Application Publication
(10) Pub. No.: US 2024/0193660 A1
(43) Pub. Date: Jun. 13, 2024

(54) SYSTEM AND METHOD FOR FACILITATING SALE OF ITEMS IN A NETWORK-BASED MARKETPLACE

(71) Applicant: Aravind Musuluri, Houston, TX (US)

(72) Inventor: Aravind Musuluri, Houston, TX (US)

(21) Appl. No.: 18/537,797

(22) Filed: Dec. 12, 2023

Related U.S. Application Data
(60) Provisional application No. 63/431,953, filed on Dec. 12, 2022.

(51) Int. Cl. G06Q 30/0601

(52) U.S. Cl. CPC G06Q 30/0627

(57) ABSTRACT

Systems and methods for listing items in a network-based marketplace by sellers with information from one or more intellectual properties for the items are disclosed. The systems and methods include listing items with intellectual property fields, searching the listing items with intellectual property keywords and highlighting items in the marketplace with one or more intellectual properties.

### CROSS REFERENCE TO RELATED APPLICATION

This application claims priority to U.S. Provisional Application Ser. No. 63/431,953 entitled “System and Method For Facilitating Sale Of Items In A Network-Based Marketplace” filed on Dec. 12, 2022, which is incorporated herein by reference.

### TECHNICAL FIELD

The present disclosure generally relates to electronic commerce, and more particularly, in one example embodiment, to a system and method for selling items in a network-based marketplace.

### BACKGROUND

The statements in this section merely provide background information related to the present disclosure and may not constitute prior art.

The fundamental changes brought by the Internet and its subset, the World Wide Web (“Web”), have created new network-based marketplaces that provide sellers with opportunities to offer their items to potential buyers online. The items may be offered for sale in an auction-format or in a fixed-price-format. Some sellers may be occasional sellers selling a few items, while other sellers may be power sellers selling hundreds or thousands of items.

Typically, in a network-based marketplace (hereinafter referred to as “marketplace”), sellers connect to servers supporting selling of items and list their items for sale. In order to list the items in an efficient manner and to attract buyers, the seller has to specify the name of the item to be sold, a good description of the item, a starting bid price, and a listing category.

When creating a listing for an item in a marketplace, a seller who may not be an expert about the item may be unaware of information to include in the listing. The seller may perform multiple searches in the marketplace to find current listings for the same or similar items and see what other sellers have done. However, the multiple-searching and comparison process is time consuming and may be inaccurate. Also, the seller has to repeat the process for every item that the seller intends to sell.

Even in the instances where the seller is an expert, the marketplace may not be effective in capturing all the details from the seller. For example, oftentimes an item that a seller wishes to sell in the marketplace has a patent associated with it. In the absence of a patent number field for an item, a seller may be forced to specify the patent number for the item in the description or some other catch-all field. This prevents buyers from effectively finding items.

For example, consider the description “Andrew Hicks Improved Pencil Eraser. We specialize in rare and antique stationery. We recently sold a Jackson pencil with patent no. 302. Visit our store frequently” for an exemplary item listed in the marketplace. A buyer in the marketplace will find the exemplary item searching using the keywords “patent” and “302”. However, the exemplary item is not an item with patent no. 302.

Further, by merely specifying a patent number in the description, a buyer may not find the item by the patent inventor as the marketplace doesn't understand the significance of a patent number. In order for the buyer to find the item by either the patent number or the patent inventor, the seller is forced to specify both the patent number and patent inventor which is tedious for the seller.

Still further specifying patent number in text fields will prevent finding items within a particular range. For example, consider the description “Andrew Hicks Improved Pencil Eraser for sale. The patent no. for the eraser is 3725” for an exemplary item listed in the marketplace. A buyer would not be able to search and find the exemplary item using the search query “items with patent no. less than 4000”.

As the listings for items in the marketplace by sellers are incomplete, inaccurate, and/or ineffective, a seller may lose sales as buyers may not find the items that the seller listed even though the items that the seller listed may be of interest to the buyer.

Since marketplaces support an ever increasing number of sellers selling a wide array of items, there remains a need to assist sellers in creating effective listings easily by the companies operating the marketplaces. Effective listings also help buyers easily locate the items that they are interested in the marketplace.

### SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

According to an embodiment, a method for facilitating sale of items in a network-based marketplace is provided. The method includes, accepting from a seller a query comprising of intellectual property keyword(s) describing one or more intellectual properties for an item that the seller wishes to sell in a network-based marketplace, searching and identifying one or more intellectual properties matching some or all the query's conditions, determining one or more intellectual properties for the item from the one or more identified intellectual properties, and listing the item in the marketplace with information from the one or more associated intellectual properties.

In one embodiment, the seller aids in determining the one or more intellectual properties for the item.

In one embodiment, a category for the item is identified from the one or more intellectual properties for the item.

In one embodiment, the item is listed with drawing(s) from the one or more intellectual properties for the item.

In one embodiment, a price for the item is suggested to the seller based on the one or more intellectual properties for the item.

In one embodiment, the item is listed with document(s) from the one or more intellectual properties for the item.

In one embodiment, the item is listed with explicit and/or implicit intellectual properties field(s).

In one embodiment, the item is highlighted to distinguish the item from other items listed in the marketplace without at least one intellectual property.

In one embodiment, the seller is rewarded based on one or more criteria for listing the item with one or more intellectual properties.

In one embodiment, the query comprises of operator(s) and/or modifiers.

In another embodiment, a method for facilitating buying of items in a network-based marketplace is provided. The method includes, listing an item, in the marketplace that a seller wishes to sell with information from the one or more intellectual properties for the item in intellectual property field(s), accepting from a buyer in the marketplace a query comprising of intellectual property keyword(s), searching and identifying one or more items listed in the marketplace matching some or all the query's conditions and presenting the one or more identified items to the buyer.

In one embodiment, the items presented to the buyer are sorted.

In one embodiment, the item is presented to the buyer with intellectual properties document(s).

In one embodiment, the item is presented with intellectual properties field(s).

In one embodiment, the item is highlighted while presenting the item to distinguish the item from other items listed in the marketplace without intellectual properties.

In one embodiment, the item is personalized while presenting the item based on the buyer profile and/or historical purchases by the buyer in the marketplace.

In one embodiment, the query comprises of operator(s) and/or modifier(s).

In one embodiment, the intellectual property field(s) are explicit and/or implicit.

In another aspect of the present disclosure is provided with a system comprising of processing hardware and memory configured to perform the functions and operations associated with the above disclosed methods.

### BRIEF DESCRIPTION OF THE DRAWINGS

The drawings described herein are for illustration purposes only and are not intended to limit the scope of the present disclosure in anyway. Throughout the disclosure, like elements are represented by like reference numerals, which are given by way of illustration only and thus are not limitative of the various embodiments.

Other objects and advantages of the present disclosure will become apparent to those skilled in the art upon reading the following detailed description of the preferred embodiments, in conjunction with the accompanying drawings, wherein:

FIG. 1 is a block diagram illustrating an exemplary marketplace environment in accordance with an embodiment of the present disclosure.

FIG. 2 is a block diagram of an exemplary computing device of FIG. 1.

FIG. 3 depicts an exemplary (graphical user interface) GUI that may be presented by the marketplace environment of FIG. 1 to a seller for searching IP.

FIG. 4 depicts exemplary IP results that may be presented to a seller by the marketplace environment of FIG. 1 in response to a search operation by the seller.

FIG. 5 depicts an exemplary GUI that may be presented by the marketplace environment of FIG. 1 to a seller to list an item in the marketplace.

FIG. 6 depicts an exemplary item listed in the marketplace by a seller in the marketplace environment of FIG. 1.

FIG. 7 depicts an exemplary GUI that may be presented by the marketplace environment of FIG. 1 to a buyer for searching items listed in the marketplace.

FIG. 8 depicts exemplary items listed in the marketplace presented to a buyer by the marketplace environment of FIG. 1 in response to a search operation by the buyer.

FIG. 9 is a flow diagram of a method for listing an item for sale in the marketplace.

FIG. 10 is a flow diagram of a method for searching items listed in the marketplace.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

Intellectual property (IP) in accordance with the present disclosure refers to a patent or a trademark.

Information from an IP may include, the IP document itself, information from the IP document, data about the IP, data computed from information in the IP document and combinations thereof.

IP for an item in accordance with the present disclosure refers to the item having been produced/manufactured according to the disclosures in the IP. For example, IP for an exemplary item “Andrew Hicks Improved Pencil Eraser” manufactured according to the disclosures in patent No. 3725 is the patent with patent No. 3725. Note that an item may have multiple IPs.

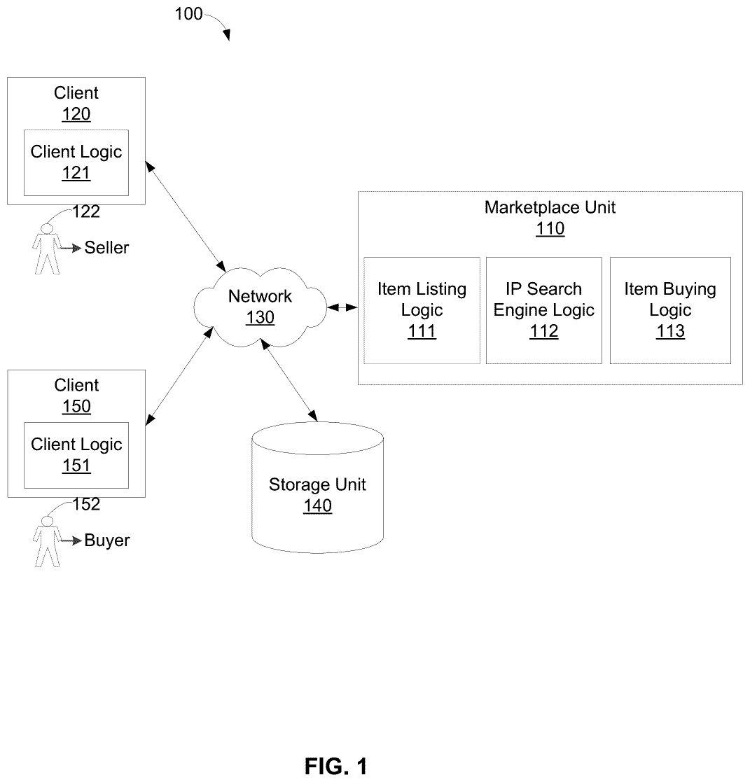

FIG. 1 depicts a system 100 for selling items in a marketplace in accordance with an exemplary embodiment of the present disclosure. It will be understood and appreciated by those of ordinary skill in the art that the computing system architecture 100 shown in FIG. 1 is merely an example of one suitable computing system and is not intended to suggest any limitation as to the scope of use or functionality of the present invention. Neither should the computing system architecture 100 be interpreted as having any dependency or requirement related to any single module/component or combination of modules/components illustrated therein.

The system 100 comprises a marketplace unit 110, a client 120, a client 150, and a storage unit 140. The marketplace unit 110, the client 120, the client 150, and the storage unit 140 all communicate over a network 130.

The network 130 can include any type of network known in the art or future-developed. In this regard, the network 130 may be an Ethernet, a local area network (LAN), or a wide area network (WAN), e.g., the Internet, or a combination of networks.

The marketplace unit 110, the client 120, and the client 150 may be a dedicated or shared server including but not limited to any type of application server, database server, or file server configurable and combinations thereof. The marketplace unit 110, the client 120, and the client 150 may include, but are not limited to, a computer, handheld unit, mobile unit, consumer electronic unit, or the like.

The exemplary marketplace unit 110 comprises of item listing logic 111, IP search engine logic 112 and item buying logic 113.

In the exemplary marketplace unit 110, the item listing logic 111 may be configured to assist sellers in listing their items for sale in the marketplace.

The marketplace unit 110 further comprises of IP search engine logic 112. The IP Search engine logic 112 may be configured to search for one or more IP related to a query comprising of IP keyword(s).

The marketplace unit 110 further comprises of item buying logic 113. The item buying logic 113 may be configured to assist buyers in identifying and buying items that may be of interest to them in the marketplace.

The storage unit 140 is configured to store information associated with selling items in the marketplace. In various embodiments, such information may include, without limitation, items, sellers, buyers, IP documents, information associated with IP documents, data about the IP, such as but not limited to, documents, metadata, links, indexes, and the like. In embodiments, the storage unit 140 is configured to be searchable. It will be understood and appreciated by those of ordinary skill in the art that the information stored in association with the storage unit 140 may be configurable and may include any information relevant to selling items in the marketplace. The content and volume of such information are not intended to limit the scope of embodiments of the present disclosure in any way. Further, though illustrated as a single, independent component, the storage unit 140 may, in fact, be a plurality of storage units, for instance a database cluster, portions of which may reside on the marketplace unit 110, the client 120, and the client 150, another external computing device (not shown), and/or any combination thereof. The single unit depictions are meant for clarity, not to limit the scope of embodiments in any form.

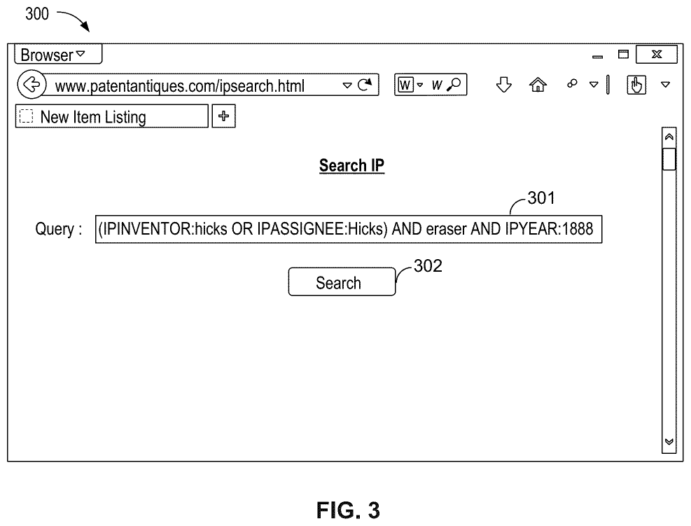

A seller 122 through the client logic 121 on the client 120 may enter details about an item with IP for listing in the marketplace. The client logic 121 may comprise, for example, an Internet browser; however, other types of client logic 121 for interfacing with the seller 122 and for communicating with the marketplace unit 110 may be used in other embodiments of the present disclosure. The client logic 121 transmits the item details to the marketplace unit 110 via the network 130. Upon receiving the item details the item listing logic 111 of the marketplace unit 110 lists the item in the marketplace. The listing of the item by the seller 122 in the marketplace is further explained with reference to FIG. 3 through FIG. 5.

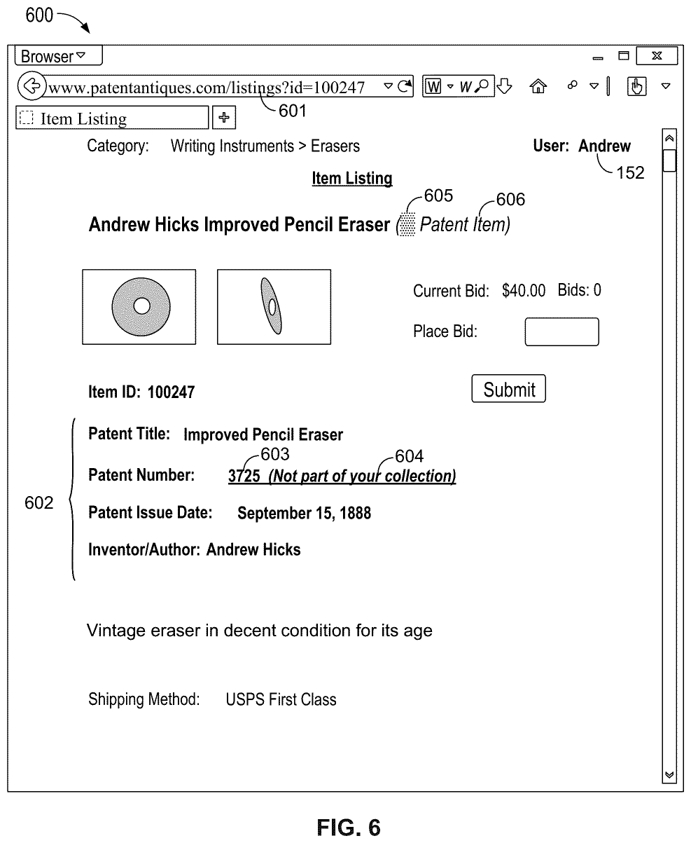

A buyer 152 through the client logic 151 on the client 150 may browse or search for items listed in the marketplace. The client logic 151 may comprise, for example, an Internet browser; however, other types of client logic 151 for interfacing with the buyer 152 and for communicating with the marketplace unit 110 may be used in other embodiments of the present disclosure. Upon receiving a request for item(s) listed in the marketplace, the item buying logic 113 of the marketplace unit 110 transmits the item listing(s) to the client logic 151 via the network 130. Buying of an item in the marketplace is further explained with reference to FIG. 6 through FIG. 8.

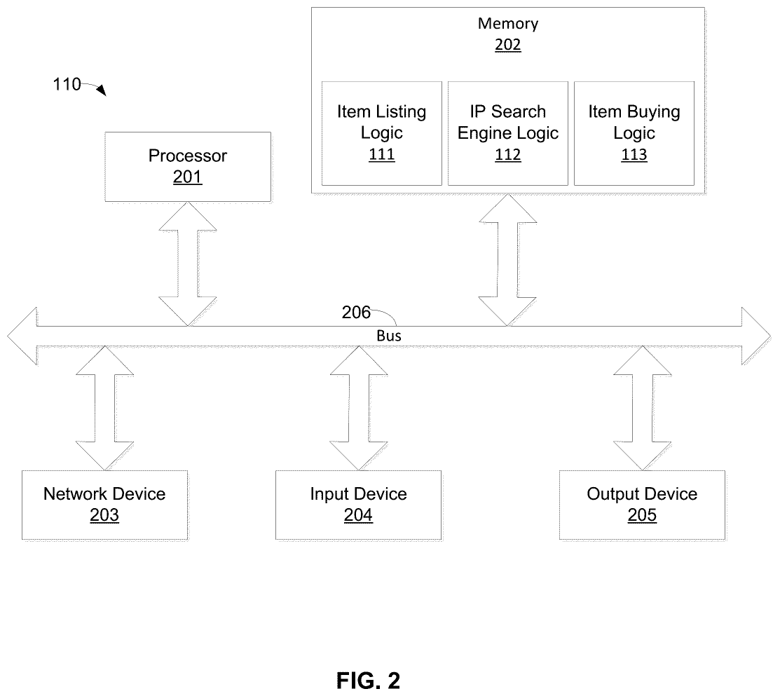

In some preferred embodiments, the marketplace unit 110 is shown in FIG. 2. It should be noted, however, that embodiments are not limited to implementation on such computing devices, but may be implemented on any of a variety of different types of computing units within the scope of embodiments hereof. The marketplace unit 110 (as shown in FIG. 1) is only one example of a suitable computing/search environment and it is not intended to suggest any limitation as to the scope of use or functionality of the disclosure.

In some embodiments, the marketplace unit 110 may include a bus 206, a processor 201, memory 202, network device 203, input device 204, and an output device 205. Bus 206 may include a path that permits communication among the components of the marketplace unit 110.

The item listing logic 111, the IP search engine logic 112 and the item buying logic 113 are stored as software in memory 202.

The memory 202 may be any type of computer memory known in the art or future-developed for electronically storing data and/or logic, including volatile and non-volatile memory. In this regard, memory 202 can include random access memory (RAM), read-only memory (ROM), flash memory, any magnetic computer storage unit, including hard disks, floppy discs, or magnetic tapes, and optical discs.

The processor 201 comprises processing hardware for interpreting or executing tasks or instructions stored in memory 202. Note that the processor 201 may be a microprocessor, a digital processor, or other type of circuitry configured to run and/or execute instructions.

The network device 203 may be any type of network unit (e.g., a modem) known in the art or future-developed for communicating over a network 130 (FIG. 1). In this regard, the marketplace unit 110 (FIG. 1) communicates with the storage unit 140 (FIG. 1), the client 120 (FIG. 1), the client 150 (FIG. 1) over the network 130 (FIG. 1) via the network device 203.

The input device 204 is any type of input unit known in the art or future-developed for receiving data. As an example, the input device 204 may be a keyboard, a mouse, a touch screen, a serial port, a scanner, a camera, or a microphone.

The output device 205 may be any type of output unit known in the art or future-developed for displaying or outputting data. As an example, the output device 205 may be a liquid crystal display (LCD) or other type of video display unit, a speaker, or a printer.

Note that the disclosure may also be practiced in a distributed computing environment where tasks or instructions of marketplace unit 110 (FIG. 1) are performed by multiple computing units communicatively coupled to the network.

Further note that, the marketplace unit 110 (FIG. 1) components may be implemented by software, hardware, firmware or any combination thereof. In the exemplary marketplace unit 110, depicted by FIG. 1, all the components are implemented by software and stored in memory 202.

FIG. 3 depicts an exemplary graphical user interface (GUI) that may be used in an embodiment of the present disclosure. Such GUI may be displayed to the seller 122 (FIG. 1) by the client logic 121 (FIG. 1). The GUI 300 comprises of a text field 301 for entering a query comprising of IP keyword(s) describing IP for an item that the seller 122 wishes to sell in the marketplace and a search bottom 302. The search button 302 which when clicked or selected results in the query entered in the text field 301 being transmitted to the IP search engine logic 112 (FIG. 1) of the marketplace unit 110 (FIG. 1) over the network 130 (FIG. 1).

The IP search engine logic 112 (FIG. 1) supports the use of operators which are well known in the art. The operators supported by the IP search engine logic 112 may be negation, conjunction and disjunction. In the GUI 300, text field 301 comprises of conjunction operator (“AND”) and disjunction operator (“OR”).

The IP search engine logic 112 (FIG. 1) further supports the use of modifiers. A modifier is a predefined code word in a syntax specified by the IP search engine logic 112 and entered into the text field 301 and are not interpreted as keyword(s) by the IP search engine logic 112. In the exemplary embodiment of the present disclosure, the code word is case insensitive and is entered in a syntax where in the modifier code word is always followed by a “:” and may be followed by IP keyword(s). In the text field 301, assuming the modifier for IP inventor is “IPINVENTOR”, placing “IPINVENTOR” before the IP keyword “hicks” narrows the search to IP with inventor comprising of “hicks”. Similarly, modifier “IPASSIGNEE” before the IP keyword “Hicks” narrows the search to IP with assignee comprising of “hicks” and modifier “IPYEAR” before the IP keyword “1888” narrows the search to IP which are granted in the year 1888. Note that the modifiers are not limited to “IPASSIGNEE” and “IPYEAR”. In other embodiments other modifiers may be used to modify keyword(s).

Note that all the IP keywords in text field 301 may not be preceded by a modifier. In the text field 301, the IP keyword “eraser” is not preceded by any modifier and the IP search engine logic 112 (FIG. 1) may search for IP with the IP keyword “eraser” occurring anywhere within the information from the IP.

Note that in one embodiment, the IP keyword(s) may be entered by the seller across multiple text fields. In another embodiment, the seller may click or select buttons or other GUI components instead of typing the operator(s) and/or modifier(s). In another embodiment, IP keywords, operators and/or modifiers are case insensitive. In another embodiment, operators and/or modifiers may be implicit. In yet another embodiment, operators, modifiers and/or keyword(s) may be inferred from the text and/or images describing the item.

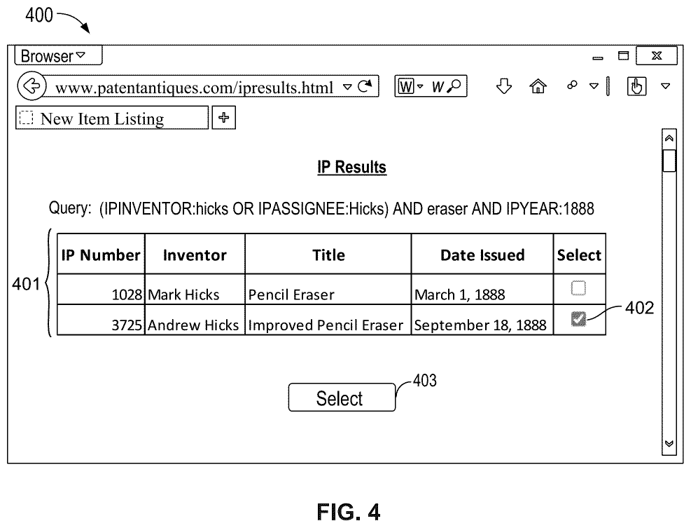

FIG. 4 depicts an exemplary IP results page 400 in accordance with an embodiment of the present disclosure. When a seller enters IP keyword(s) in the text field 301 (FIG. 3) and clicks the search button 302 (FIG. 3), the IP search engine logic 112 (FIG. 1) of the marketplace unit 110 (FIG. 1) may examine the storage unit 140 (FIG. 1) for IP matching the IP keyword(s) and returns the matching IP results 401 to the seller in the form of the IP result page 400. Note that in other embodiments, results 401 may have fewer or more columns presenting more or less information about IP results to the seller. In yet another embodiment, results 401 may include diagrams from the IP matching the IP keyword(s).

In one embodiment, the seller on page 400 may select one or more IP for the item that matches the item that the seller intends to sell in the marketplace by selecting the checkbox and clicking or selecting select button 403. In another embodiment, the system may automatically select the one or more IP for the item from the IP results as a result of performing the search on GUI 300 (FIG. 3), in which case displaying page 400 to the seller is optional. For example, if the search for IP results in only one IP then the system may automatically select the single IP for the item.

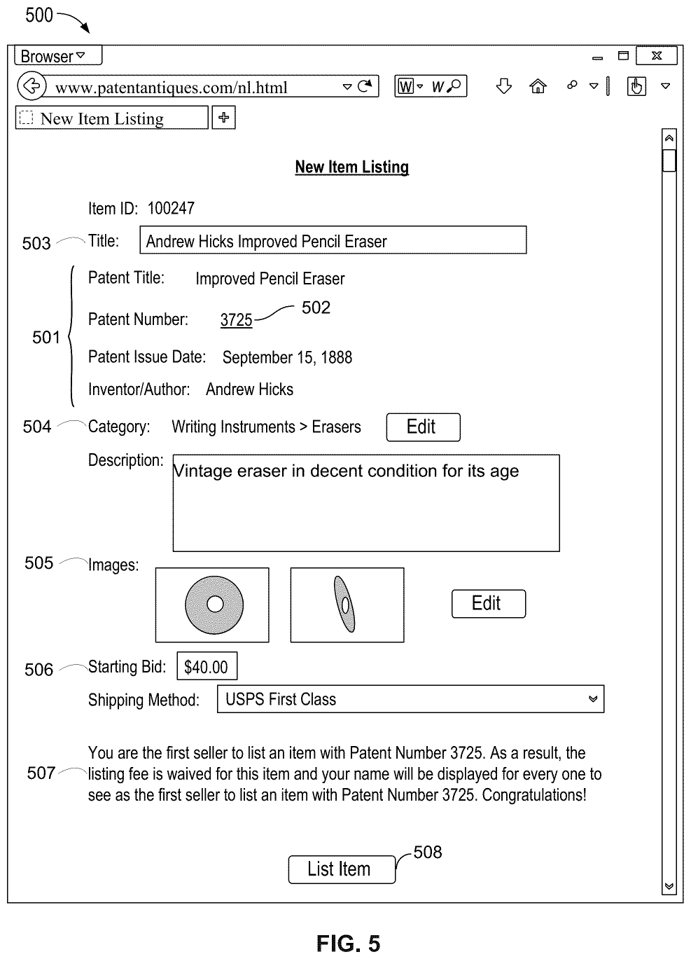

FIG. 5 depicts an exemplary GUI that may be presented to a seller in accordance with an embodiment of the present disclosure. When an IP is determined for an item that the seller wishes to sell in the marketplace, the item listing logic 111 (FIG. 1) of the marketplace unit 110 (FIG. 1) may generate GUI 500. The GUI 500 comprises of IP field(s) 501 which may be prefilled with information from the IP for the item. Note that in other embodiments of the present disclosure there may be fewer or additional IP field(s) on the GUI 500.

In one embodiment, the item may be listed with the associated TP document. For example, clicking or selecting IP number value 502 may open the IP document or link to an external location, such as but not limited to, www.uspto.gov, where the IP document may be located.

In the GUI 500, other fields may be prefilled for the seller with information from the IP associated with the item which may be further edited by the seller. For example, the title field 503 may be prefilled with a combination of inventor and IP title, category field 504 may be prefilled based on IP classification and/or natural language processing of the IP title, images 505 may be prefilled with drawings from the associated IP, and price 506 may be suggested based on the historical selling prices for items with the same associated IP.

In one embodiment, the seller may be rewarded based on one or more criteria for listing an item with one or more IP. In the exemplary GUI 500, the seller is rewarded 507 for being the first one to list an item with the patent number 502.

In yet another embodiment, the criterion may be listing predetermined items with one or more IP. For example, but not limited to, the seller may be rewarded he/she is first to list 10 items with TP in the marketplace. Note that the rewards may be monetary and/or non-monetary. Further note that, in one embodiment, the seller is rewarded only if the item sells in the marketplace.

In one embodiment, GUI 500 may be presented to the seller with editable IP field(s) 501 for the seller to populate IP field(s). If the seller populates IP field(s) then searching for IP in GUI 300 (FIG. 3) and selecting IP in GUI 400 (FIG. 4) for an item may be optional.

In yet another embodiment, the IP field(s) 501 may be inferred from the other field(s) entered by the seller in the GUI 500 using, for example, Natural Language Processing (NLP). Assuming (not shown) the seller entered “Andrew Hicks Improved Pencil Eraser for sale. The patent no. for the eraser is 3725” in the description field in the GUI 500, the value for Patent number field in the IP field(s) 501 will be inferred as “3725” using NLP techniques well known in the art. As another example, assuming (not shown) the seller entered “Andrew Hicks Improved Pencil Eraser. We specialize in rare and antique stationery. We recently sold a Jackson pencil with patent no. 302. Visit our store frequently” in the description field in the GUI 500, the value for Patent number field in the IP field(s) 501 will not be inferred as “302” using NLP techniques well known in the art. If the IP field(s) are inferred from other field(s) then searching for IP in GUI 300 (FIG. 3) and selecting IP in GUI 400 (FIG. 4) for an item may be optional.

In the GUI 500, when the seller is finished editing, the seller may click or select list item button 508 which when clicked or selected results in the item being listed in the marketplace.

FIG. 6 depicts an exemplary item with an IP listed in the marketplace by a seller in the marketplace environment of FIG. 1. Buyer 152 (FIG. 1) in the marketplace may locate the item in the marketplace by visiting the URL 601. The listing comprises of IP field(s) 602 and an IP document (not shown) which the buyer 152 may view by clicking or selecting IP number value 603.

Note that IP field(s) 602 in the GUI 600 are explicit IP field(s) i.e. displayed to the user on the GUI 600. GUI 600 further comprises of implicit IP field(s) i.e. IP field(s) with information from the IP for the item and not displayed on the GUI 600. An example of implicit IP field not displayed on the GUI 600 is “Patent Class:” with a value of “400/20”. Implicit IP field(s) may be useful in searching and finding items in the marketplace.

In one embodiment, the item buying logic 113 (FIG. 1) may personalize the item listing page 600 based on the buyer visiting the page. In the exemplary listing page 600, the item buying logic 113 examined the items previously purchased by the buyer 152 (FIG. 1) and determined that the buyer 152 didn't buy an item with IP number 603. The item listing logic 113 personalized the listing page 600 for the buyer 152 by adding the note 604. Note that in other embodiments of the present disclosure there may be other personalization's based on the buyer profile and/or historical purchases by the buyer in the marketplace.

In one embodiment, the item buying logic 113 (FIG. 1) may present the item with IP to a buyer highlighting the item to distinguish the item from other items listed in the marketplace without associated IP. In the exemplary listing page 600, next to the title an image 605 and a text 606 are added to indicate that the item listed on page 600 has as IP.

Note that the item with IP may be distinguished from other items without IP in the marketplace using images, text and/or presentation semantics, such as, but not limited to, fonts, text size, colors, borders and patterns.

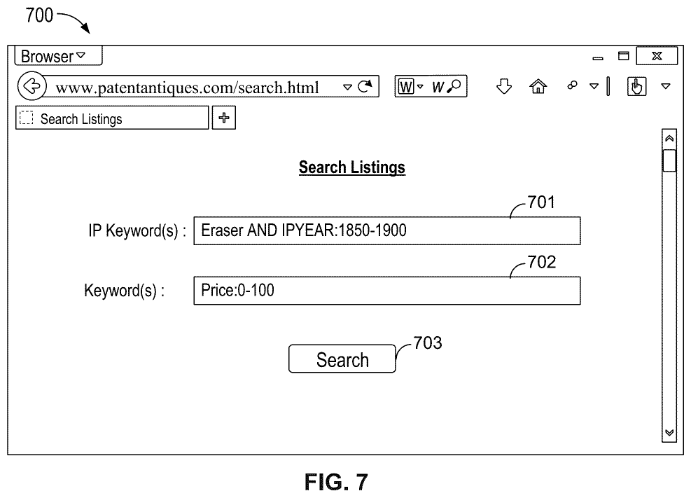

FIG. 7 depicts an exemplary GUI that may be used in an embodiment of the present disclosure. Such GUI may be displayed to the buyer 152 (FIG. 1) by the client logic 151 (FIG. 1). The GUI 700 comprises of text field 701, text field 702 and search button 703. The buyer 152 may enter a query comprising of IP keyword(s) and/or keyword(s) for the items that the buyer 152 wishes to buy in the marketplace. The buyer may enter the portion of the query comprising of IP keyword(s) into the text field 701. The buyer may enter the portion of the query comprising of keyword(s) into the text field 702. The search button 703 which when clicked or selected results in the query entered in the text field 701 and the text field 702 being transmitted to the item buying logic 113 (FIG. 1) of the marketplace unit 110 (FIG. 1) over the network 130 (FIG. 1).

The item buying logic 113 (FIG. 1) supports the use of operators which are well known in the art. The operators supported by the item buying logic 113 may be negation, conjunction and disjunction. In the GUI 700, text field 701 comprises of conjunction operator (“AND”).

Similar to the TP search engine logic 112 (FIG. 1), the item buying logic 113 (FIG. 1) supports the use of modifiers. A modifier is a predefined code word in a syntax specified by the item buying logic 113 and entered into the text field 701 and are not interpreted as keyword(s) by the item buying logic 113. In the exemplary embodiment of the present disclosure, the code word is case insensitive and is entered in a syntax where in the modifier code word is always followed by a “:” and may be followed by IP keyword(s). In the text field 701, modifier “IPYEAR” before the IP keyword “1850-1900” narrows the search to items listed in the marketplace to those items with IP granted in the year 1850 through 1900.

Note that all the IP keyword(s) in text field 701 may not be preceded by a modifier. In the text field 701, the IP keyword “eraser” is not preceded by any modifier and the item buying logic 113 (FIG. 1) may search for items with IP listed in the marketplace with the IP keyword “eraser” occurring anywhere within the information from the IP.

Note that for some modifiers IP keyword is optional. For example, modifier “IPALL” may not require an IP keyword as the modifier “IPALL” matches all items in the marketplace with an IP.

Note that in one embodiment, the IP keyword(s) and keyword(s) may be entered by the buyer across multiple text fields. In another embodiment, the buyer may click or select buttons or other GUI components instead of typing the operator(s) and modifier(s). In another embodiment, IP keywords, keyword(s), operators and/or modifiers are case insensitive. In yet another embodiment, operators and/or modifiers may be implicit.

Note that identifying IP field(s) allows for searching, sorting and filtering of item with IP items in the marketplace.

The search button 703 which when clicked or selected results in the IP keyword(s) entered in the text field 701 and keyword(s) entered in the text field 702 being transmitted to the item buying logic 113 (FIG. 1) of the marketplace unit 110 (FIG. 1) over the network 130 (FIG. 1).

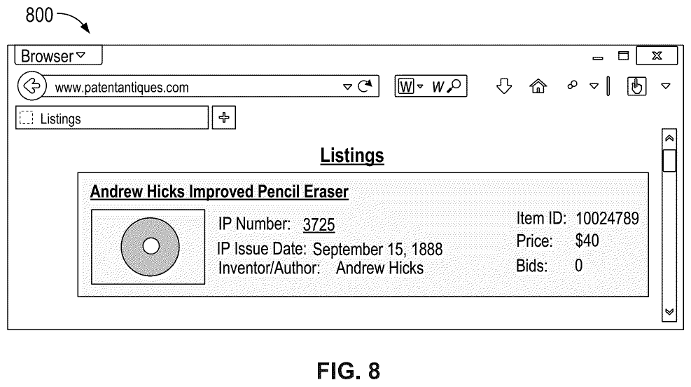

FIG. 8 depicts an exemplary items results page 800 in accordance with an embodiment of the present disclosure. When a buyer clicks the search button 703 (FIG. 7), the item buying logic 113 (FIG. 1) of the marketplace unit 110 (FIG. 1) may examine the storage unit 140 (FIG. 1) for items listed in the marketplace matching the query comprising of IP Keyword(s) entered in text field 701 and keyword(s) entered in text field 702 and returns the listings to the buyer in the form of the listing page 800.

Note that the items with IP listed on page 800 may be highlighted to distinguish item listed on page 800 without IP.

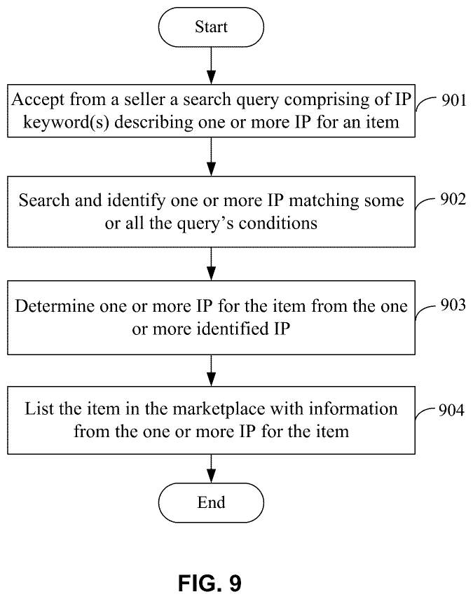

FIG. 9 is a flow diagram of a method for listing an item for sale in the marketplace. In step 901, the marketplace unit 110 (FIG. 1) may accept from a seller a search query comprising of IP keyword(s) describing on or more IP for an item. In step 902, the marketplace unit 110 may search and identify one or more IP matching some or all the query's conditions. In step 903, the marketplace unit 110 may determine one or more IP for the item from the one or more identified IP. In step 904, the item is listed in the marketplace with information from the one or more IP for the item by the marketplace unit 110.

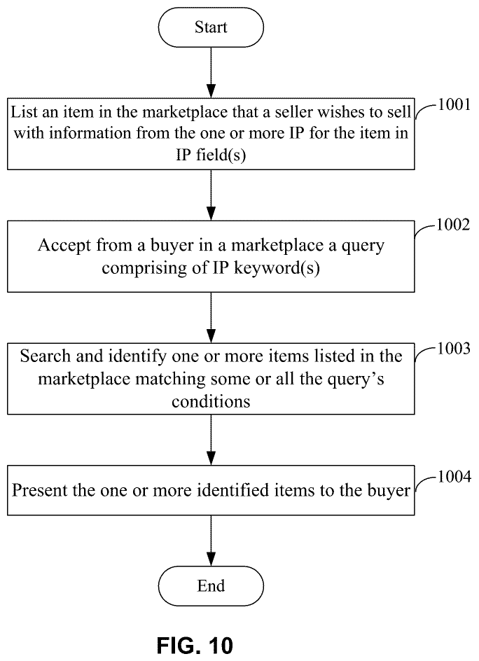

FIG. 10 is a flow diagram of a method for searching items for sale in the marketplace. In step 1001, the marketplace unit 110 (FIG. 1) may list an item in the marketplace that a seller wishes to sell with information from the one or more IP for the item in IP field(s). In step 1002, the marketplace unit 110 may accept a query from a buyer comprising of IP keyword(s). In step 1003, the marketplace unit 110 may search and identify one or more items listed in the marketplace matching some or all the query's conditions. In step 952, the item identified by the marketplace unit 110 may be presented to the buyer.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A method executable on a network-based marketplace computing device comprising a processor, comprising:
(a) accepting, by the processor, from a seller a query comprising of intellectual property keyword(s) describing one or more intellectual properties for an item that the seller wishes to sell in the network-based marketplace;
(b) searching and identifying, by the processor, one or more intellectual properties matching some or all the query's conditions;
(c) determining, by the processor, one or more intellectual properties for the item from the one or more identified intellectual properties; and
(d) listing the item in the marketplace with information from the one or more intellectual properties for the item.

2. The method of claim 1, wherein the seller aids the processor in determining the one or more intellectual properties for the item.

3. The method of claim 1, wherein a category for the item is identified from the one or more intellectual properties for the item.

4. The method of claim 1, wherein the item is listed with drawing(s) from the one or more intellectual properties for the item.

5. The method of claim 1, wherein a price for the item is suggested to the seller based on the one or more intellectual properties for the item.

6. The method of claim 1, wherein the item is listed with documents from the one or more intellectual properties for the item.

7. The method of claim 1, wherein the item is listed with explicit and/or implicit intellectual properties field(s).

8. The method of claim 1, wherein the item is highlighted to distinguish the item from other items listed in the marketplace without at least one intellectual property.

9. The method of claim 1, wherein the seller is rewarded based on one or more criteria for listing the item with one or more intellectual properties.

10. The method of claim 1, wherein the query comprises of operator(s) and/or modifier(s).

11. A method executable on a network-based marketplace computing device comprising a processor, comprising:
(a) listing an item, by the processor, in the marketplace that a seller wishes to sell with information from the one or more intellectual properties for the item in intellectual property field(s);
(b) accepting, by the processor, from a buyer in the marketplace a query comprising of intellectual property keyword(s);
(c) searching and identifying, by the processor, one or more items listed in the marketplace matching some or all the query's conditions; and
(d) presenting the one or more identified items to the buyer.

12. The method of claim 11, wherein the presented items are sorted.

13. The method of claim 11, wherein at least one item is presented with intellectual properties document(s).

14. The method of claim 11, wherein at least one item is presented with intellectual properties field(s).

15. The method of claim 11, wherein at least one item is highlighted while presenting to distinguish the at least one item from other items listed in the marketplace without intellectual properties.

16. The method of claim 11, wherein at least one item is personalized while presenting based on the buyer profile and/or historical purchases.

17. The method of claim 11, wherein the query comprises of operator(s) and/or modifier(s).

18. The method of claim 11, wherein intellectual property field(s) are explicit and/or implicit.
